(19) United States
(12) Patent Application Publication
(10) Pub. No.: US 2017/0200107 A1
(43) Pub. Date: Jul. 13, 2017

(54) CORRELATION PROCESSES FOR IDENTIFYING CAUSE AND EFFECT RELATIONSHIPS IN COMPLEX BUSINESS ENVIRONMENTS

(71) Applicants: Mark Ducros Stouse, Phoenix, AZ (US); Peter James Houston, Kirkland, WA (US); Thomas Bishop, Austin, TX (US); Kyle Brantley, Houston, TX (US); Davinder Virk, Secunderabad (IN)

(72) Inventors: Mark Ducros Stouse, Phoenix, AZ (US); Peter James Houston, Kirkland, WA (US); Thomas Bishop, Austin, TX (US); Kyle Brantley, Houston, TX (US); Davinder Virk, Secunderabad (IN)

(21) Appl. No.: 15/393,044

(22) Filed: Dec. 28, 2016

Related U.S. Application Data
(60) Provisional application No. 62/275,966, filed on Jan. 7, 2016.

(51) Int. Cl. G06Q 10/06

(52) U.S. Cl. CPC G06Q 10/06393

(57) ABSTRACT

A set of proof correlation processes for identifying the two equal-length ranges (corresponding to time periods) contained within two discrete time data series (one range per series) that exhibit the highest correlation score when evaluated by a method that mimic how humans visually assess and score correlation is disclosed. The set of proof correlation processes include scoring the strength of correlation exhibited by ranges of data values corresponding to time periods and within two discrete time data series, and determining the number of time intervals that the variable series must be shifted (either forward or backward in time) with respect to the static series to exhibit the maximum correlation score for the given range pairs.

### CLAIM OF BENEFIT TO PRIOR APPLICATION

This application claims benefit to U.S. Provisional Patent Application 62/275,966, entitled “Correlation Processes For Identifying Cause And Effect Relationships In Complex Business Environments,” filed Jan. 7, 2016. The U.S. Provisional Patent Application 62/275,966 is incorporated herein by reference.

### BACKGROUND

One of the greatest challenges faced by business executives is determining whether ‘cause and effect’ relationships exist between their investments in marketing and sales activities (such as TV advertising) and business metrics (such as deal generation, deal expansion and deal velocity, among other outcomes). The challenge arises as a result of several factors, including:

Fluctuations within time data series of interest (such as revenue per month) caused by ‘seasonal’ behaviors (such as higher vehicle sales around certain holidays), and ‘environmental’ factors outside the control of the company (such as advertising campaigns run by competitors), make it difficult to separate actual trends contained within the data from ‘noise’ that distorts the results of analysis.

Differences in the numerical scales of time data series of interest (such as a series representing spending on TV advertising—expressed in millions of dollars—and a second series representing unit volumes of new truck sales—expressed in thousands) make direct comparisons difficult.

Time ‘leads and lags’ between ‘cause’ actions (such as running a series of TV commercials during a major sporting event) and ‘effect’ indicators (such as an increase in the number of cars sold per month) often result in analyses producing misleading and/or inaccurate results. Exacerbating the negative effects of time leads/lags is the tendency of lead/lag factors to change (i.e., shorten, lengthen, and/or oscillate) unpredictably over time.

Traditional methods in the field of Statistics for calculating the strength of correlations (such as computing R values using correlation coefficient formulae) tend to ‘score’ potential correlations differently than humans do, resulting in users of the methods (via various software products) perceiving a high percentage of both ‘false positive’ and ‘false negative’ errors in the outputs from the methods.

Despite the above-described factors that present a challenge to executives, presently there is no (nor has there ever been) system or software that has connected all of the necessary data into a correlated pattern of which marketing investments deliver financial value and which do not.

Therefore, what is needed is a way to help executives and other business professionals identify and understand ‘cause and effect’ relationships between spending and business metrics in a way that connects all of the necessary data into a correlated pattern of which marketing investments deliver financial value and which do not.

### BRIEF DESCRIPTION

Some embodiments of the invention include a set of novel correlation processes for identifying and understanding cause and effect relationships between spending and business metrics, while accounting for differences in data, time, and perception. In some embodiments, the set of correlation processes includes a cause and effect correlation process, a time series data smoothing process, a time series data scaling process, a correlation detection and assessment process, and a conflict resolution process which consumes output from the correlation detection and assessment process and resolves conflicts where overlapping ranges within two time data series include multiple correlated periods, each with a different lag factor and correlation quality score.

In some embodiments, the set of correlation processes are associated and ordered according to an overall mathematical method. In some embodiments, the mathematical method is the cause and effect correlation process. In some embodiments, the cause and effect correlation process ties the correlation processes together to score the strength of correlation exhibited by ranges of data values (corresponding to time periods) associated with two discrete time data series (static and variable time data series) and determine the number of time intervals that the variable series must be shifted (either forward or backward in time) with respect to the static series to exhibit the maximum correlation score for the given range pairs.

In some embodiments, the cause and effect correlation process identifies and evaluates ‘cause and effect’ relationships while accounting for ‘noisy data’, data range differences, time lag factors, and how humans perceive correlation. In this way, the cause and effect correlation process helps executives and other business personnel to identify and understand ‘cause and effect’ relationships between spending and business metrics in a way that connects all of the necessary data into a correlated pattern of which marketing investments deliver financial value and which do not.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having thus described the invention in general terms, reference is now made to the accompanying drawings, which are not necessarily drawn to scale, and which show different views of different example embodiments.

FIG. 1 conceptually illustrates a cause and effect correlation process for identifying and understanding cause and effect relationships between spending and business metrics, while accounting for differences in data, time, and perception in some embodiments.

FIG. 2 conceptually illustrates a smoothing process for smoothing fluctuations and exposing underlying trends within time data series in some embodiments.

FIG. 3 conceptually illustrates an example graph that includes an unaltered time data series curve and a smoothed curve that results from applying smoothing process to the unaltered time data series curve.

FIG. 4 conceptually illustrates a scaling process for normalizing numerical scales of two input time data series in some embodiments to enable accurate and direct comparisons of the two input time data series.

FIG. 5 conceptually illustrates an unscaled graph of two input time data series curves at an input scale and a scaled graph of the two input time data series curves at a normalized scale.

FIG. 6 conceptually illustrates a correlation scoring process for assessing and scoring ranges of data points in time data series in some embodiments.

FIG. 7 conceptually illustrates a correlation detection, assessment, and scoring process in some embodiments.

FIG. 8 conceptually illustrates a graph that includes two time data series curves before correlation detection, assessment, and scoring.

FIG. 9 conceptually illustrates a graph that includes a time data series curve that is shifted due to a range of data points in the time data series that is highly correlated to another range of data points in another time data series curve.

FIG. 10 conceptually illustrates a conflict resolution process for identifying overlapping ranges of data points within two time data series and resolving conflicts of the overlapping ranges in some embodiments.

FIG. 11 conceptually illustrates a series of conflict resolution stages during which overlapping ranges of data points within two time data series are identified and resolved.

FIG. 12 conceptually illustrates a network architecture of a cloud-network correlation detection and scoring system in some embodiments that identifies and understands cause and effect relationships between spending and business metrics, while accounting for differences in data, time, and perception.

FIG. 13 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments include a set of correlation processes for identifying and understanding cause and effect relationships between spending and business metrics, while accounting for differences in data, time, and perception. In some embodiments, the set of correlation processes includes a cause and effect correlation process, a time series data smoothing process, a time series data scaling process, a correlation detection and assessment process, and a conflict resolution process which consumes output from the correlation detection and assessment process and resolves conflicts where overlapping ranges within two time data series include multiple correlated periods, each with a different lag factor and correlation quality score.

In some embodiments, the set of correlation processes are associated and ordered according to an overall mathematical method. In some embodiments, the mathematical method is the cause and effect correlation process. In some embodiments, the cause and effect correlation process ties the correlation processes together to score the strength of correlation exhibited by ranges of data values (corresponding to time periods) associated with two discrete time data series (static and variable time data series) and determine the number of time intervals that the variable series must be shifted (either forward or backward in time) with respect to the static series to exhibit the maximum correlation score for the given range pairs.

In some embodiments, the cause and effect correlation process identifies and evaluates ‘cause and effect’ relationships while accounting for ‘noisy data’, data range differences, time lag factors, and how humans perceive correlation. In this way, the cause and effect correlation process helps executives and other business personnel to identify and understand ‘cause and effect’ relationships between spending and business metrics in a way that connects all of the necessary data into a correlated pattern of which marketing investments deliver financial value and which do not.

In this specification, there are several descriptions of methods and processes that are implemented as software applications or computer programs which run on computing devices to perform the steps of the correlation methods and/or processes. However, it should be noted that for the purposes of the embodiments described in this specification, the word “method” is used interchangeably with the word “process”. Correlation detection, assessment, or scoring processes or methods for identifying and understanding cause and effect relationships are described, therefore, by reference to example methods that conceptually illustrate steps of correlation detection, assessment, and scoring methods for identifying and understanding cause and effect relationships. Also, correlation detection, assessment, and scoring processes or methods for identifying and understanding cause and effect relationships are described, therefore, by reference to example correlation methods and processes.

As stated above, one of the greatest challenges faced by business executives is determining whether ‘cause and effect’ relationships exist between the amount of money they spend on marketing activities (such as TV advertising) and business metrics (such as new sales leads per month and total revenue). Embodiments of the invention described in this specification solve such problems by a mathematical method for scoring the strength of correlation exhibited by ranges of data values (corresponding to time periods) associated with two discrete time data series and determining the number of time intervals that the variable series must be shifted (either forward or backward in time) with respect to the static series to exhibit the maximum correlation score for the given range pairs. In some embodiments, the mathematical method includes a cause and effect correlation process. In some embodiments, the cause and effect correlation process ties the correlation processes together to score the strength of correlation exhibited by ranges of data values (corresponding to time periods) associated with two discrete time data series (static and variable time data series) and determine the number of time intervals that the variable series must be shifted (either forward or backward in time) with respect to the static series to exhibit the maximum correlation score for the given range pairs.

The embodiments described in this specification differ from and improve upon currently existing options. In particular, some embodiments differ because unlike other methods for identifying and evaluating cause and effect relationships included within discrete time data series, the numerical methods described in this specification produce accurate results when input time data series contain high levels of ‘noise’ and/or use different range scales, and/or when ‘effect’ leads or lags ‘cause’ by some number of time periods (such as six months). Furthermore, the methods used for scoring correlation relationships are uniquely highly tuned to mimic how humans assess and score the strength of correlation.

To use the correlation processes of the present disclosure, a person may interact with a software application, software service (e.g., a web-based software as a service application), or operate a product with embedded functionality that implements the correlation processes (e.g., an embedded program, a process module or plug-in that is connected with another software application that calls upon one or more aspects of the embedded functionality to carry out one or more functions of the correlation processes). The software or product may be designed to aggregate, federate, and assess the relationships between different data streams over time, ultimately producing a clear understanding of the efficacy, efficiency and impact between various stimuli and various reactions.

For purposes of the inventive embodiments described in this specification, a lexicography is included here to define some terms and terminology used throughout the description. Specifically, the term “discrete” refers to collections of distinct, chronologically-ordered data points that correspond to the values exhibited by a target when measured at regular points in times. For example, a time data series could include discrete data points for “the closing price of a stock on the last day of the month for each month in the period between January 1990 and April 2015.”

As defined in this specification, discrete time data series refers to a static data series (or the ‘static series’) and a variable data series (or the ‘variable series’). By way of example, it is possible to use ‘TV advertising’ as the static series and ‘unit volumes of truck sales’ as the variable series. Then identify the periods of time where increased spending on TV advertising (i.e., ‘cause’) resulted in increased truck sales (i.e., ‘effect’) and the number of months between cause and effect for each period.

Also, in various passages of this disclosure, the terms “continuous” and “analogue” or “analog” are recited in connections with time data functions. Such terminology, when described as “continuous time data functions”, “analogue time data functions”, or “analog time data functions”, represent the corollary to discrete time data series. Furthermore, these functions represent an effectively unlimited number of individual data points versus collections of individual data points captured at discrete points in time. An example of a continuous time data function is a radio wave where the value of the wave at any point in time can be calculated by solving the corresponding wave equation for the desired point in time.

Several more detailed embodiments are described in the sections below. Section I describes a cause and effect correlation process and a proof correlation engine that implements the cause and effect correlation process. Section II describes a smoothing process. Section III describes a scaling process. Section IV describes a correlation detection and assessment process. Section V describes a conflict resolution process. Section VI describes a correlation detection and scoring system that identifies and understands cause and effect relationships between spending and business metrics, while accounting for differences in data, time, and perception. Section VII describes an electronic system that implements one or more of the methods and processes.

### I. Cause and Effect Correlation Process and Proof Correlation Engine

In some embodiments, the mathematical method comprises a set of correlation processes or numerical methods that identify and evaluate ‘cause and effect’ relationships while accounting for ‘noisy data’, data range differences, time lag factors, and how humans perceive correlation. In this way, the mathematical method helps executives and other business personnel to identify and understand ‘cause and effect’ relationships between spending and business metrics in a way that connects all of the necessary data into a correlated pattern of which marketing investments deliver financial value and which do not.

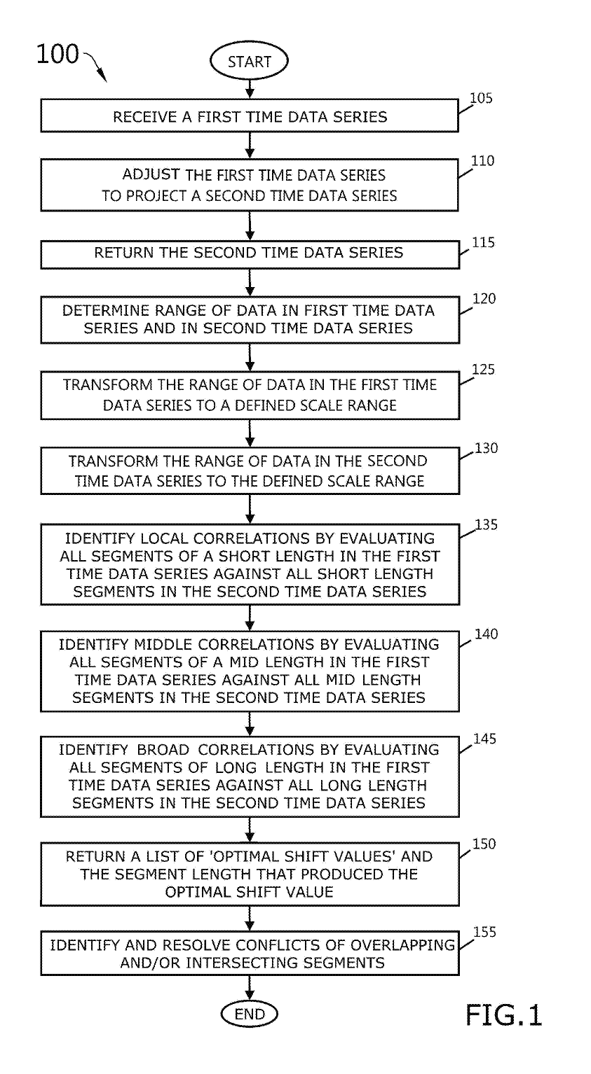

By way of example, FIG. 1 conceptually illustrates a cause and effect correlation process 100 for identifying and understanding cause and effect relationships between spending and business metrics, while accounting for differences in data, time, and perception. In some embodiments, the cause and effect correlation process 100 performs several sets of steps for smoothing time data series, scaling time data series, and correlating time data series, as well as resolving conflicts in the correlation of time data series.

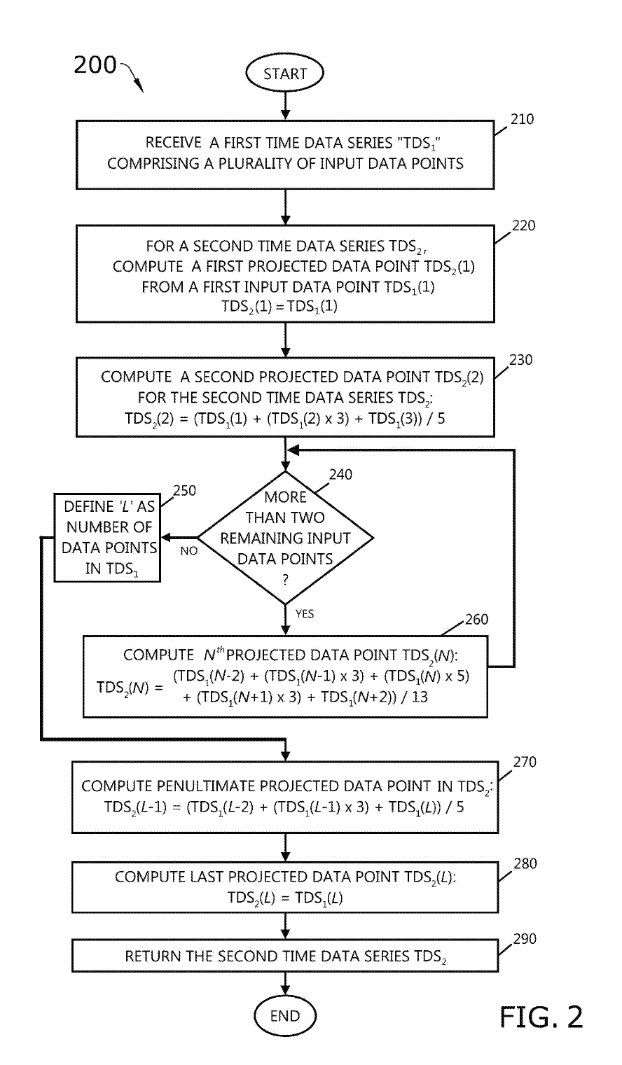

In some embodiments, the cause and effect correlation process 100 starts by performing steps with operations for smoothing fluctuations in the first time data series which results in a second time data series that is ‘smoothed’. As shown in this figure, the cause and effect correlation process 100 receives (at 105) a first time data series. The cause and effect correlation process 100 of some embodiments then adjusts (at 110) the first time data series to project a second time data series. After projecting the second time data series, the cause and effect correlation process 100 returns (at 115) the second time data series. The operations in steps 105, 110, and 115 for smoothing fluctuations in the first time data series are described in further detail below, by reference to FIG. 2.

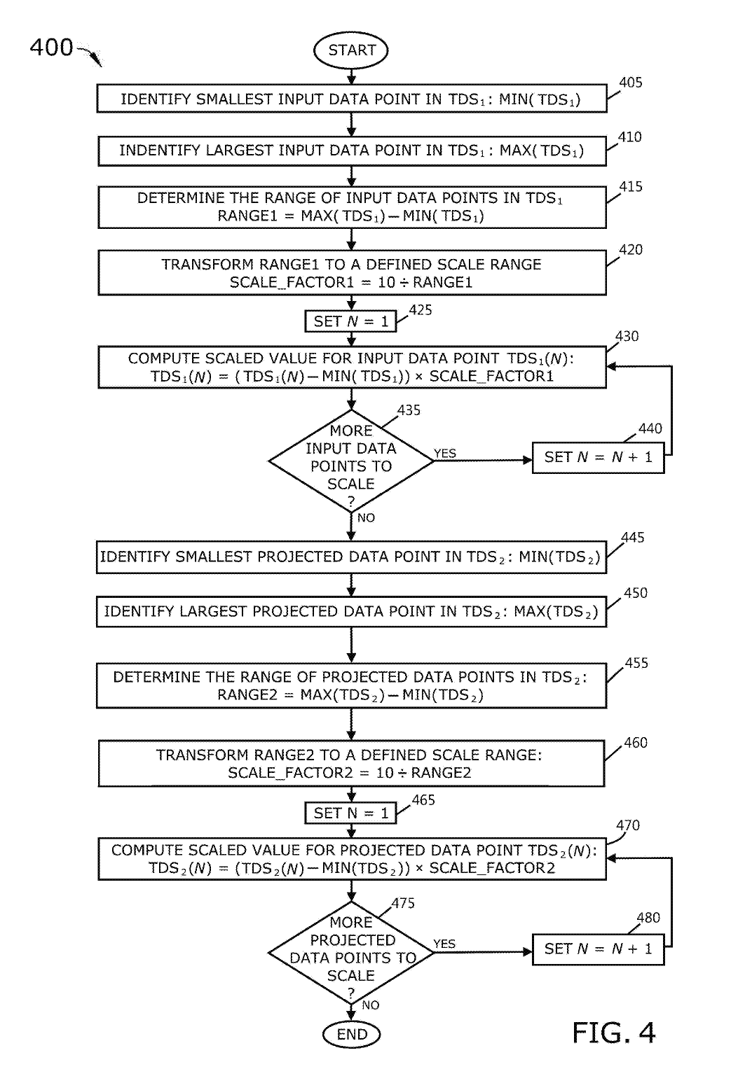

In some embodiments, the cause and effect correlation process 100 continues with a set of steps 120, 125, and 130 for scaling the first and second time data series, thereby allowing accurate comparison normalized data and corresponding curves of the scaled time data series. Thus, the cause and effect correlation process 100 of some embodiments determines (at 120) a range of data in the first time data series and in the second time data series. Next, the cause and effect correlation process 100 transforms (at 125) the range of data in the first time data series to a defined scale range. The cause and effect correlation process 100 then transforms (at 130) the range of data in the second time data series to the defined scale range. The operations in steps 120, 125, and 130 for scaling the first and second time data series are described in further detail below, by reference to FIG. 4.

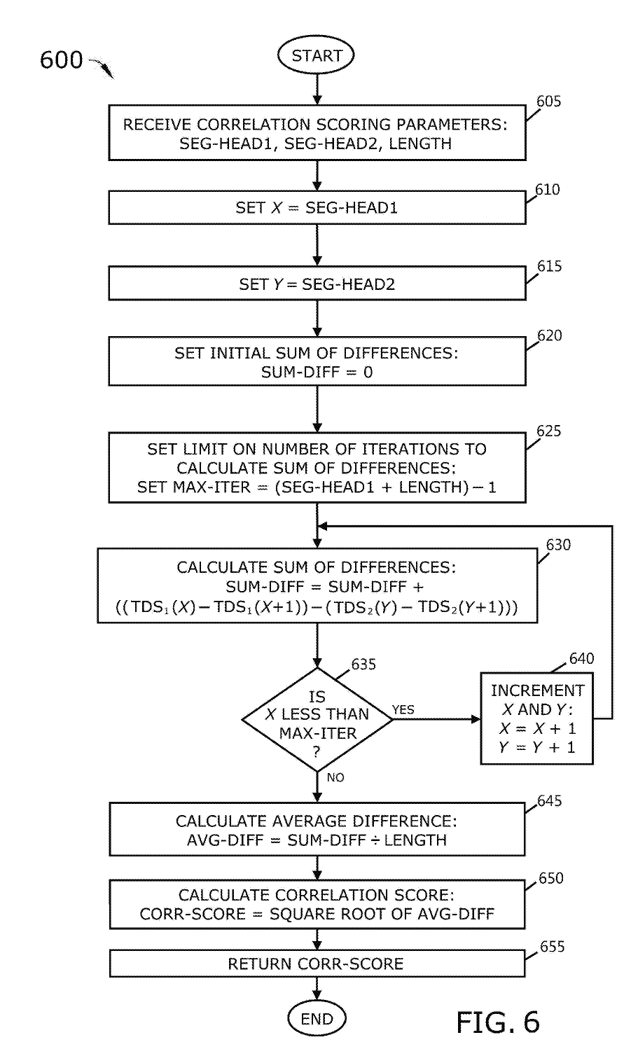

The cause and effect correlation process 100 of some embodiments continues with a set of steps 135, 140, 145, and 150 for correlating ranges of data points in time data series by walking through the time series data curves in relation to several ranges of data points in the time data series and scoring the ranges of data points based on their correlation value with respect to another time data series curve. Accordingly, the cause and effect correlation process 100 of some embodiments identifies (at 135) local correlations by evaluating all segments of a short length in the first time data series against all short length segments in the second time data series. Next, the cause and effect correlation process 100 of some embodiments identifies (at 140) middle correlations by evaluating all segments of mid length in the first time data series against all mid length segments in the second time data series. Then the cause and effect correlation process 100 identifies (at 145) broad correlations by evaluating all segments of long length in the first time data series against all long length segments in the second time data series. After identifying local correlations, middle correlations, and broad correlations, the cause and effect correlation process 100 of some embodiments returns (at 150) a list of ‘optimal shift values’ and the segment length that produced the optimal shift value. The operations in steps 135, 140, 145, and 150 for correlating ranges of data points in time data series are described in further detail below, by reference to FIGS. 6 (for segment correlation scoring) and 7 (for segment correlation walking).

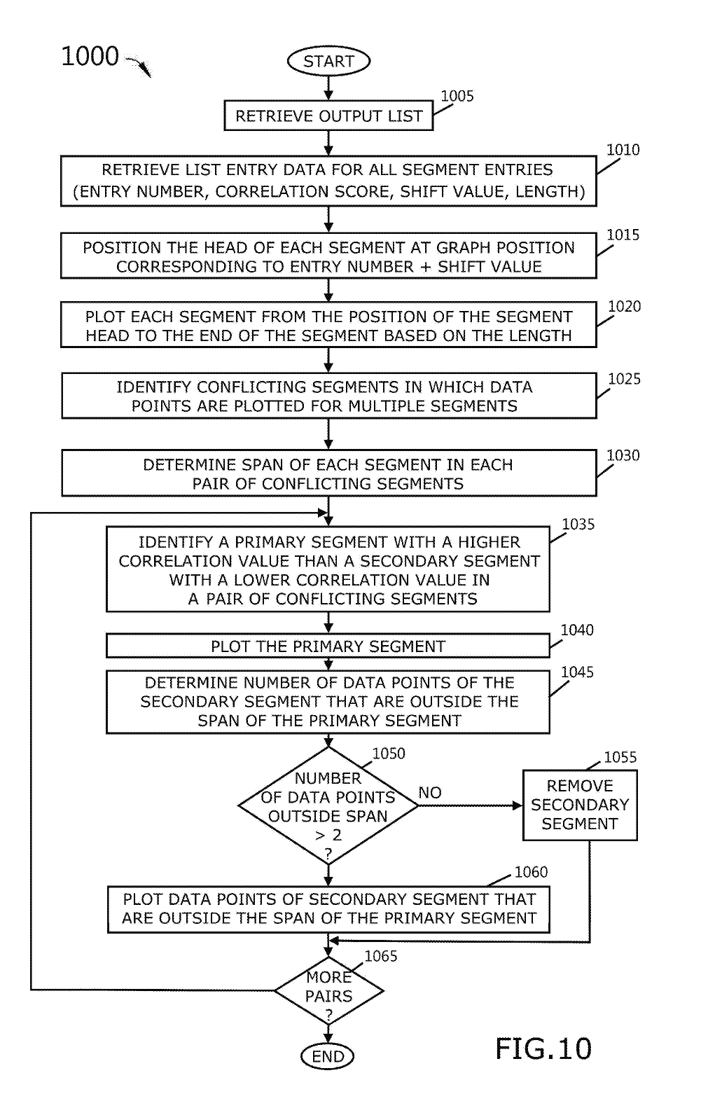

Next, the cause and effect correlation process 100 of some embodiments identifies and resolves (at 155) conflicts of overlapping and/or intersecting segments. Identifying and resolving conflicts of overlapping and/or intersecting segments is described below, by reference to FIG. 10.

In some embodiments, the mathematical method is reduced to practice by way of a Proof Correlation Engine (PCE) process comprising a set of numerical methods that perform the steps of the mathematical method. In some embodiments, the PCE process is implemented as a software application (also known as the Proof Correlation Engine software application, the Proof Correlation Engine application, the PCE software application, the PCE application, or simply, the PCE). In some embodiments, the PCE software application performs the steps of one or more of the numerical methods in the set of numerical methods.

In addition to identifying time leads/lags, the numerical methods employed by the PCE ensure and improve the accuracy of PCE outputs by (i) smoothing fluctuations within time data series using an adaptive method that determines and applies the optimum amount of smoothing factors needed to expose, but not distort, underlying trends contained with series, (ii) normalizing the numerical scales of the two input time data series to enable accurate direct comparisons, (iii) implementing multiple proprietary numerical methods that mimic how humans identify, assess, and score ranges within two time data series that are correlated, and determines and uses the methods that will yield the most accurate results when applied to a given pair of time data series, and (iv) implementing numerical methods that process the output from correlation analysis methods so they can be displayed in graphs and other visual representations in ways that are sensible and easy for product users to understand.

It is important to note that there are no practical limits to the size or length of time data series that the numerical methods employed by the PCE can process. Further, the methods are fully generalized and can be applied to any two discrete time data series (i.e. the methods are not restricted or optimized in any way such that they will operate correctly only if the inputs represent marketing data). For example, the methods could be used to evaluate the relationships between a consumer confidence index over time and prices of stocks listed on the NASDAQ Stock Exchange during the same time period. The output of such an analysis might expose a correlation relationship such as “When Consumer Confidence rises, the stock price of Company X consistently rises four months later.”

In some embodiments, the set of numerical methods comprises four numerical methods including a smoothing method, a series scaling method, a correlation detection and assessment method, and a conflict resolution method which consumes output from the correlation detection and assessment method and resolves conflicts where overlapping ranges within two time data series include multiple correlated periods, each with a different lag factor and correlation quality score.

### II. Smoothing Method

In some embodiments, the smoothing method receives a first time data series as input, adjusts the first time data series to project a second time data series, and returns the second time data series as output. In some embodiments, the first time data series comprises a set of input data points and the second time data series comprises a set of projected data points. For instance, when the first time data series (e.g., ‘TDS₁’) is provided to the smoothing method as input, the smoothing method will return the second time data series (e.g., ‘TDS₂’) as output. The set of projected data points in TDS₂ represent a projection of the set of input data points in TDS₁ where each particular input data point in TDS₁ is adjusted using a weighted average method that incorporates the two input data points to the immediate left and the immediate right of the particular input data point. Thus, the weighted averaging involves five input data points (e.g., a particular input data point, two input data points to the left of the particular input data point, and two input data points to the right of the particular input data point) in each adjustment of an input data point from which a corresponding data point is projected by weighted average computation. The weighting factors employed by the method are designed to moderate the amount of change that occurs between any two adjacent data points to reveal underlying trends within the data without altering the data so much that the trends are fundamentally altered or obscured.

Assuming the notation ‘TDS₁(1)’ represents the value of the first data point in the input time data series named ‘TDS₁’, ‘TDS₁(2)’ represents the value of the second data point in the input time data series named ‘TDS₁’, (etc.) and the notation ‘TDS₂(1)’ represents the value of the first data point in the output time data series named ‘TDS₂’, ‘ TDS₂ (2)’ represents the value of the second data point in the output time data series named ‘TDS₂’, (etc.) the mode of operation of the smoothing method is as follows:

Computing the first element in the output time data series TDS₂:

TDS₂(1)=TDS₁(1)

Computing the second element in the output time data series TDS₂:

$${TDS}_{2} ( 2 ) = \frac{{TDS}_{1} ( 1 ) + ( {TDS}_{1} ( 2 ) \times 3 ) + {TDS}_{1} ( 3 )}{5}$$

Computing the N^{th} element in the time data series, where N>=2 and N<=(# elements in time data series-2):

$${TDS}_{2} ( N ) = \frac{\begin{matrix}{TDS}_{1} ( N - 2 ) + ( {TDS}_{1} ( N - 1 ) \times 3 ) + ( {TDS}_{1} ( N ) \times 5 ) + \\ ( {TDS}_{1} ( N + 1 ) \times 3 ) + {TDS}_{1} ( N + 2 )\end{matrix}}{13}$$

Next to last element in the time data series:

$$Define L = Number of elements in the time data series$$

$${TDS}_{2} ( L - 1 ) = \frac{{TDS}_{1} ( L - 2 ) + ( {TDS}_{1} ( L - 1 ) \times 3 ) + {TDS}_{1} ( L )}{5}$$

Last element in the time data series:

TDS₂(L)=TDS₁(L)

It is important to note that the ‘weighting factors’ of 1, 3, and 5 shown above are for illustration. Because these factors can have a significant effect on the outcome of the correlation analysis (for example, a poor selection of weights can result in over-smoothing or under-smoothing) the first stage of the method is to examine the target time data series, assess the variability of the data, and determine a set of weights that will produce an output that is smoothed optimally for subsequent correlation analysis.

By way of example, FIG. 2 conceptually illustrates a smoothing process 200 for smoothing fluctuations and exposing underlying trends within time data series. As shown in this figure, the smoothing process involves a time data series that includes multiple input data points which, when plotted on a graph, form an unaltered curve with fluctuations between data point values. The smoothing process 200 of some embodiments smoothes these fluctuations without causing distortions in the overall curve. Thus, the smoothing process 200 starts when it receives (at 210) a first time data series ‘TDS₁’, which includes several input data points.

Next, the smoothing process 200 of some embodiments starts to project smoothed data points based on the input data points of the first time data series. The projected data points are for a second time data series ‘TDS₂’. Thus, the smoothing process 200 computes (at 220) a first projected data point TDS₂(1) from a first input data point TDS₁(1). A relationship between the first projected data point TDS₂(1) and the first input data point TDS₁(1) may be denoted as TDS₂(1)=TDS₁(1).

In some embodiments, the smoothing process 200 computes (at 230) a second projected data point TDS₂(2) for the second time data series ‘TDS₂’. In some embodiments, the smoothing process 200 computes the second projected data point TDS₂(2) as a quotient of a weighted sum of input data points. For instance, TDS₂(2) may be computed as (TDS₁(1)+(TDS₁(2)×3)+TDS₁(3))/5 (or another carefully selected weighting value).

In some embodiments, the smoothing process 200 determines (at 240) whether there are more than two remaining input data points. When there more than two remaining input data points, the smoothing process 200 of some embodiments transitions to step 260 to compute more projected data points, which is described in further detail below. On the other hand, when there are not more than two remaining input data points, the smoothing process 200 defines (at 250) a variable ‘L’ as a number of data points in time data series TDS₁. The smoothing process 200 then transitions to step 270, which is described in further detail below.

Turning back to step 260, the smoothing process 200 of some embodiments computes (at 260) the N^{th} projected data point in TDS₂(N). In some embodiments, this computation includes calculating a value for TDS₂(N) based on (TDS₁(N−2)+(TDS₁(N−1)×3)+(TDS₁(N)×5)+(TDS₁(N+1)×3)+TDS₁(N+2))/13. Next, the smoothing process 200 of some embodiments returns to step 240 to determine if there are more than two remaining input data points.

Now moving on to step 270, the smoothing process 200 of some embodiments computes (at 270) the penultimate projected data point in TDS₂. Specifically, the smoothing process 200 computes the second to last projected data point TDS₂(L−1) as (TDS₁(L−2)+(TDS₁(L−1)×3)+TDS₁(L))/5. Next, the smoothing process 200 computes (at 280) the last projected data point TDS₂(L) as TDS₂(L)=TDS₁(L). In some embodiments, the smoothing process 200 then returns (at 290) the second time data series TDS₂. Then the smoothing process 200 ends.

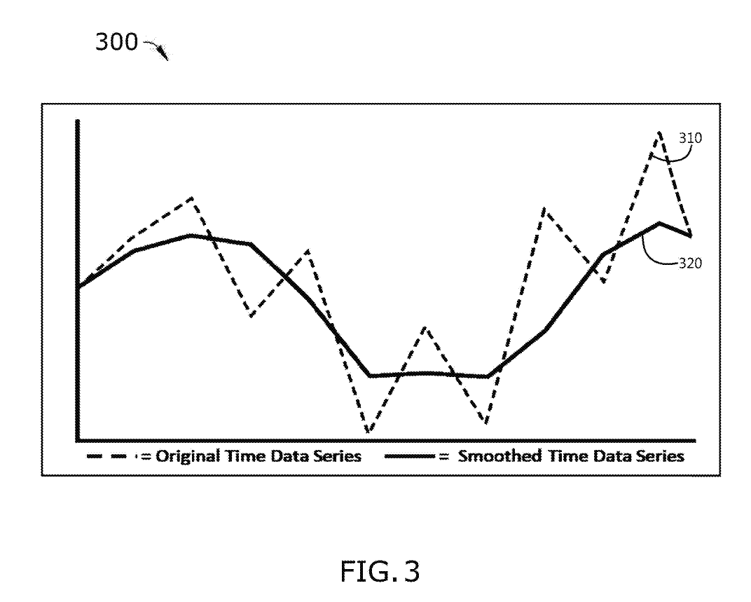

By way of example, FIG. 3 conceptually illustrates a graph 300 that includes an unaltered time data series plotted along unaltered curve 310 (shown by dashed line) and a projected time data series that is plotted along smoothed curve 320 (shown by solid line). The smoothed curve 320 is based on the same set of time series data as the unaltered time data series curve 310, but visually demonstrates how the curve gets smoothed after the smoothing method 200 has been applied.

### III. Scaling Method

In some embodiments, the series scaling method transforms the elements in a source time data series to a scale of 0-10. Once transformed, the minimum value within the transformed series equals zero (0), the maximum value in the transformed series equals ten (10), and all other time data series elements have values between zero (0) and ten (10) that are proportional to their position in the source time data series. When the scaling method is performed on two time data series, their values become directly comparable.

Assuming the notation ‘TDS₁(1)’ represents the value of the first data point in the input time data series named ‘TDS₁’, ‘TDS₁(2)’ represents the value of the second data point in the input time data series named ‘TDS₁’, (etc.) and the notation ‘TDS₂(1)’ represents the value of the first data point in the output time data series named ‘TDS₂’, ‘TDS₂ (2)’ represents the value of the second data point in the output time data series named ‘TDS₂’, (etc.) the mode of operation of the scaling method is as follows:
Define Min(TimeDataSeries)=The value of the smallest element in TimeDataSeries
Define Max(TimeDataSeries)=The value of the largest element in TimeDataSeries
Range1=Max(TDS₁)−Min(TDS₁)
ScaleFactor1=10/Range1
For all elements in TDS₁, set TDS₁(N)=(TDS₁(N)−Min(TDS₁)) ScaleFactor1
Range2=Max(TDS₂)−Min(TDS₂)
ScaleFactor2=10/Range2
For all elements in TDS₂, set TDS₂(N)=(TDS₂(N)−Min(TDS₂)) ScaleFactor2

By way of example, FIG. 4 conceptually illustrates a scaling process 400 for normalizing numerical scales of two input time data series to enable accurate and direct comparisons of the two input time data series. As shown in this figure, the scaling process 400 starts by identifying (at 405) a smallest input data point in a first time data series TDS₁. Next, the scaling process 400 identifies (at 410) a largest input data point in the first time data series TDS₁. In this specification, the smallest input data point in the first time data series TDS₁ is also referred to as MIN(TDS₁) and the largest input data point in the first time data series TDS₁ is also referred to as MAX(TDS₁).

Next, the scaling process 400 of some embodiments determines (at 415) the range of input data points in TDS₁, as expressed by the relationship RANGE1=MAX(TDS₁) −MIN(TDS₁). After the range is determined, the scaling process 400 of some embodiments transforms (at 420) RANGE1 to a defined scale range, as expressed by the relationship SCALE_FACTOR1=10/RANGE1. The scaling process 400 then sets (at 425) N=1, where N is a variable associated with a time series data point, depending on the value of N used to evaluate the time series data point.

In some embodiments, the scaling process 400 computes (at 430) a scaled value for input data point TDS₁(N), according to the relationship expressed by TDS₁(N)=(TDS₁(N)−MIN(TDS₁))×SCALE_FACTOR1. Next, the scaling process 400 determines (at 435) whether there are any more input data points to scale. Where there are more input data points to scale, the scaling process 400 increments (at 440) the value of N (e.g., N=N+1) and then transitions back to step 430 to compute a scaled value for the next input data point TDS₁(N). TDS₂.

On the other hand, when there are no more input data points to scale, the scaling process 400 moves on to identify (at 445) the smallest projected data point in TDS₂, denoted by MIN(TDS₂) and to identify (at 450) the largest projected data point in TDS₂, denoted by MAX(TDS₂).

Next, the scaling process 400 of some embodiments determines (at 455) the range of input data points in TDS₂, as expressed by the relationship RANGE2=MAX(TDS₂) −MIN(TDS₂). After the range is determined, the scaling process 400 of some embodiments transforms (at 460) RANGE2 to a defined scale range, as expressed by the relationship SCALE_FACTOR2=10/RANGE2. The scaling process 400 then sets (at 465) N=1.

In some embodiments, the scaling process 400 computes (at 470) a scaled value for projected data point TDS₂(N), according to the relationship expressed by TDS₂(N)=(TDS₂(N)−MIN(TDS₂))×SCALE_FACTOR2. Next, the scaling process 400 determines (at 475) whether there are any more projected data points to scale. When there are more projected data points to scale, the scaling process 400 increments (at 480) the value of N (e.g., N=N+1) and then transitions back to step 470 to compute a scaled value for the next projected data point TDS₂(N). When there are no more projected data points to scale, the scaling process 400 ends.

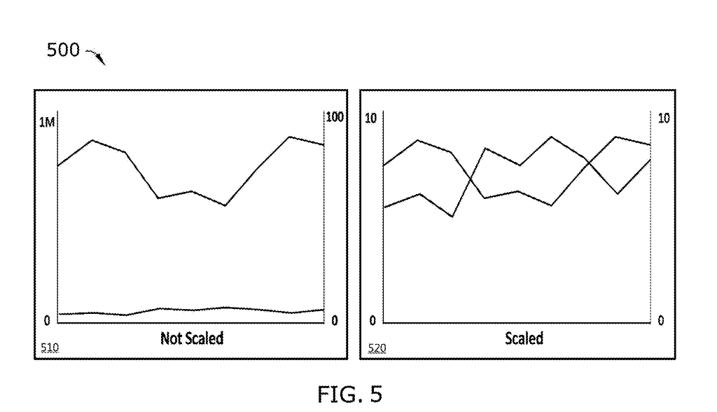

FIG. 5 conceptually illustrates an unscaled graph of two input time data series curves at an input scale and a scaled graph of the two input time data series curves at a normalized scale. In this figure, a time data series scaling example 500 is shown in which a hypothetical pair of time data series graphs 510 and 520 are shown with a first graph 510 of the time data series before scaling and a second graph 520 of the time data series after scaling.

### IV. Correlation Detection and Assessment Method

In some embodiments, the correlation detection and assessment method is performed after the two time data series have been smoothed and scaled. Thus, when the operations of the smoothing method and the scaling method have been completed, the correlation detection and assessment method will evaluate all segments (representing, for example, nine month periods within a time data series containing 4 years of monthly data) contained within Time Data Series #1 against all segments (of equal length) contained within Time Data Series #2 and return a list (with the same number of elements as the time data series used as inputs) of ‘optimal shift values’ and the segment length that produced the optimal shift value. Each shift value represents the number of periods that Time Data Series #2 must be shifted (forward or backward) to obtain the highest possible correlation score (as determined by the correlation scoring component of this method) when compared to the segment in Time Data Series #1 that begins in the same position as the shift value in question holds in the optimal shift value list. The method evaluates segments that are 7, 9, and 11 elements in length. This is done to identify correlations that are ‘local’ (i.e., a smaller number of highly correlated elements) and ‘broad’ (i.e., a larger number of less highly-correlated elements).

The correlation detection and assessment method builds the list by ‘walking down’ the first time data series, ‘pointing’ at each element in the series in turn as the ‘head’ of the segment, and assessing the segment in focus (of length 7, 9, and 11) against all possible segments of the same length in the second time data series. Once all possible segments have been examined and scored, the method records (in the list) the shift that produced the highest correlation score, the segment length that produced the highest correlation score, and the highest correlation score itself.

In some embodiments, two modes of operation for the correlation detection and assessment method can be invoked to determine a correlation quality score. Specifically, these modes of operation include a mode of operation for the time data series ‘walking’ component, and a mode of operation for the correlation scoring component.

Mode of Operation: Time Data Series Walking Component

Assuming the notation ‘TDS₁(1)’ represents the value of the first data point in the input time data series named ‘TDS₁’, TDS₁(2)′ represents the value of the second data point in the input time data series named ‘TDS₁’, etc. Further assuming the notation ‘TDS₂(1 represents the value of the first data point in the output time data series named TDS₂’, TDS₂(2)′ represents the value of the second data point in the output time data series named ‘TDS₂’, etc. With these assumptions, the mode of operation of the ‘Walking’ component of the correlation detection and assessment method is as follows (in pseudo-code format):

Define CorrelationScore(SegmentHead₁, SegmentHead₂,SegmentLength)=The correlation score returned when presented with the first element of a segment from TDS₁, the first element of a segment from TDS₂, and the number of elements (i.e., segment length) to be evaluated
Varying X from 1 to the length of TimeDataSeries₁
Varying Y from 1 to the length of TimeDataSeries₂
TempScores=CorrelationScore(TDS₁(X), TDS₂(Y), 7)
If TempScores>OutputList(X).Score then

### OutputList(X).Score=TempScore

### OutputList(X).OptimalShift=Y−X

### OutputList(X).OptimalSegmentLength=7

TempScores=CorrelationScore(TDS₁(X), TDS₂(Y), 9)
If TempScores>OutputList(X).Score then

### OutputList(X).Score=TempScore

### OutputList(X).OptimalShift=Y−X

### OutputList(X).OptimalSegmentLength=9

TempScores=CorrelationScore(TDS₁(X), TDS₂(Y), 11)
If TempScores>OutputList(X).Score then

### OutputList(X).Score=TempScore

### OutputList(X).OptimalShift=Y−X

### OutputList(X).OptimalSegmentLength=11

Mode of Operation: Correlation Scoring Component

In the Correlation Scoring Component, the same notation as defined in the ‘Walking’ component described above may be used. The ‘Walking’ component expects to be able to invoke a correlation scoring component that takes 2 segments and a segment length as input parameters and receive a correlation quality score in return. The mode of operation of the ‘Scoring’ component of the correlation detection and assessment method is as follows:

Assuming the correlation scoring component is invoked in the form of:

CorrelationScore(SegmentHead_{b} SegmentHead₂, SegmentLength),

where SegmentHead₁ is the first element of a segment from TDS₁, SegmentHead₂ is the first element of a range from TDS₂, and SegmentLength represents the number of elements (i.e., the segment length) to be evaluated by the component

Varying X from 1 to (SegmentLength−1)
SumOfDifferences=SumOfDifferences+(((TDS₁(X)−TDS₁(X+1))−((TDS₂(X)−TDS₂(X+1)))

### AverageDifference=SumOfDifferences/SegmentLength

### CorrelationScore=SquareRoot(AverageDifferences)

Note that the actual correlation scoring algorithm is based on the magnitude of the ‘differences’ between 1 period sections from Time Data Series #1 and their corresponding section from Time Data Series #2. While the correlation quality scoring of the ‘Scoring’ component in some embodiments is handled according to the above example, in some other embodiments, the ‘Scoring’ component includes a plurality of additional or other steps that deepen the ability of the correlation detection and assessment method to accurately provide a correlation quality score.

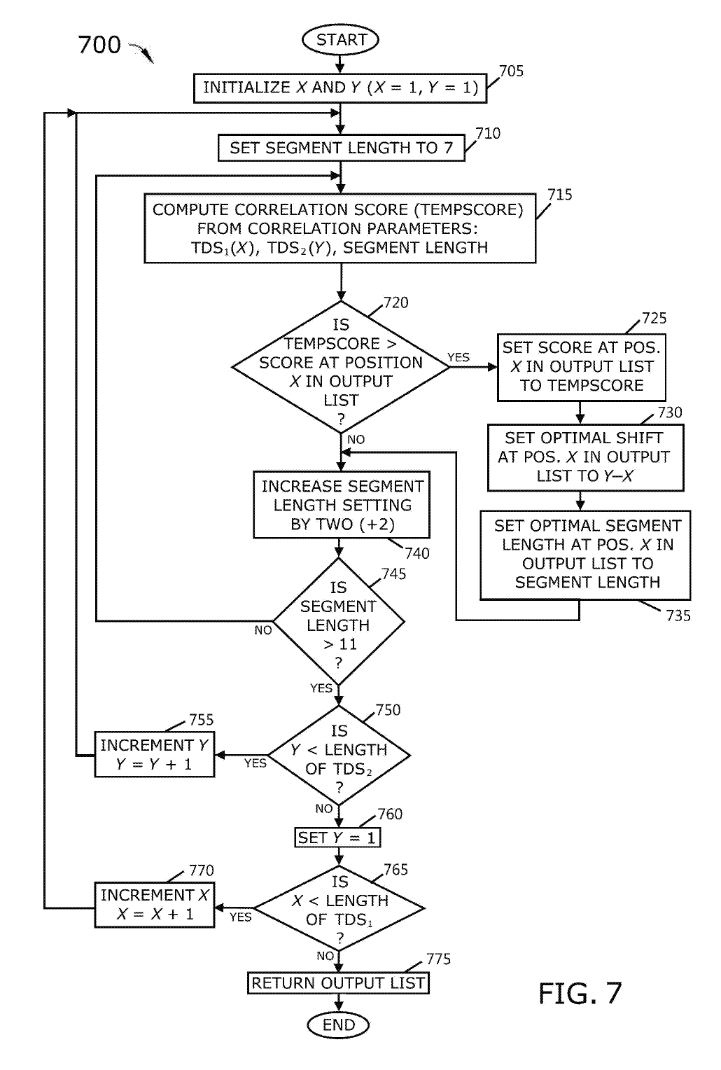

By way of example, FIG. 6 conceptually illustrates a correlation scoring process 600 for assessing and scoring ranges of data points in time data series. Although the correlation scoring process 600 can be invoked in any of several independent operational modes, the correlation scoring process 600 is often used in connection with a process for detecting, assessing, and scoring correlations of different ranges of data points between different time data series. An example of a correlation detection, assessment, and scoring process is described below, by reference to FIG. 7. In this sense, the correlation scoring process 600 is performed when the mode of operation of the correlation detection and assessment method described above involves the time data series ‘scoring’ component.

In some embodiments, the correlation scoring process 600 receives (at 605) correlation scoring parameters. Correlation scoring parameters include a first segment head corresponding to a starting point of a segment of a first time data series, a second segment head corresponding to a starting point of a segment of a second time data series, and a length of the segments being scored for how closely they are correlated. Upon receiving the correlation scoring parameters, the correlation scoring process 600 of some embodiments assigns counter variables (e.g., X and Y) for use in walking the length of the segments during correlation scoring. Thus, the correlation scoring process 600 sets X (at 610) to the value of the first segment head (e.g., SEG-HEAD1) and sets Y (at 615) to the value of the second segment head (e.g., SEG-HEAD2).

In some embodiments, the correlation scoring process 600 then sets (at 620) an initial sum of differences value (e.g., SUM-DIFF=0). Next, the correlation scoring process 600 sets a limit (at 625) on the number of iterations to calculate the sum of differences. The limit on the number of iterations is based on the length of the segments being scored. Since the starting point of any given segment varies, the iterations limit just adds the length to the starting point, and subtracts one so as not to exceed the length of the segment (e.g., MAX-ITER=(SEG-READ1+length of segment)−1).

After the preliminary parameters are set for scoring the correlation strength of segments, the correlation scoring process 600 moves forward to several steps for performing the correlation scoring calculations. In some embodiments, the correlation scoring process 600 calculates (at 630) the sum of differences at the present iteration. Specifically, the correlation scoring process 600 calculates the sum of differences by adding the existing sum of differences value to a computation of the differences between the first and second segments at their respective data points for the current iteration (e.g., SUM-DIFF=SUM-DIFF+((TDS₁(X)−TDS₁(X+1))−(TDS₂(Y)−TDS₂(Y+1))).

Next, the correlation scoring process 600 of some embodiments determines (at 635) whether X is less than the present value of the iteration limit (e.g., MAX-ITER). When X is less than the iteration limit, the correlation scoring process 600 increments (at 640) the values of X and Y (e.g., X=X+1 and Y=Y+1) and then returns to step 630 to calculate the sum of differences with the incremented values of X and Y.

On the other hand, when X is not less than the iteration limit (i.e., X is greater than or equal to the iteration limit), then the correlation scoring process 600 calculates (at 645) an average difference for the sum of differences computation. To calculate an average difference, the sum of differences is divided by the length of the segments (e.g., AVG-DIFF=SUM-DIFF/length of segments). Next, the correlation scoring process 600 calculates (at 650) a correlation score. The correlation score is calculated in some embodiments as the square root of the average difference value (e.g., CORR-SCORE=square root of AVG-DIFF). In some embodiments, after the correlation score is calculated, the correlation scoring process 600 returns the correlation score (at 655). Then the correlation scoring process 600 ends.

In returning the correlation score, the correlation scoring process 600 may return the score to the provider of the correlation scoring parameters. For example, a correlation detection, assessment, and scoring software program that implements a correlation detection, assessment, and scoring process may include a correlation scoring module that implements the correlation scoring process. When the correlation detection, assessment, and scoring software program needs to determine a correlation score for different segments of time data series, it may pass the correlation scoring parameters to the correlation scoring module, which would calculate the correlation score and then return the correlation score to the correlation detection, assessment, and scoring software program.

An example of a correlation detection, assessment, and scoring process is conceptually illustrated in FIG. 7. In some embodiments, a correlation detection, assessment, and scoring process 700 is performed when the mode of operation of the correlation detection and assessment method described above involves the time data series ‘walking’ component.

In some embodiments, the correlation detection, assessment, and scoring process 700 starts (at 705) by initializing counters X and Y (e.g., X=1, Y=1). Then the correlation detection, assessment, and scoring process 700 of some embodiments sets a first segment length. The correlation detection, assessment, and scoring process 700 will set multiple segment lengths in order to assess correlations over time between different time data series. The segment length settings depend largely on the data being assessed for any given time data series. Since some data is related to marketing investments that may mature over several months, the segment lengths set by the correlation detection, assessment, and scoring process 700 will reflect such durations. In this example, the correlation detection, assessment, and scoring process 700 sets (at 710) the segment length to seven (e.g., 7 data points in the time data series, which may reflect data over 7 months).

In some embodiments, the correlation detection, assessment, and scoring process 700 computes (at 715) a correlation score (e.g., TEMPSCORE) based on correlation parameters TDS₁(X), TDS₂(Y), and the segment length. Computing the correlation score is described in greater detail by reference to FIG. 6, above. After the correlation score is computed, the correlation detection, assessment, and scoring process 700 determines (at 720) whether the correlation score (or rather, TEMPSCORE) is greater than a score value entry (if any) in an output list. Specifically, an output list records the highest scores in relation to the starting position of a segment being assessed. In this example, the counter variable X relates to the start of the segment and the entry position in the output list. Thus, when determining whether the correlation score is greater than a score value entry at position X in the output list, the correlation detection, assessment, and scoring process 700 treats no entry at position X as an empty value, and would therefore consider the correlation score to be greater than the empty value. However, in some embodiments, the output list is initialized with values of zero (or empty values) when the correlation detection and assessment method is being performed.

Turning back to the determination (at 720) of whether the correlation score is greater than the score value at position X in the output list, the correlation detection, assessment, and scoring process 700 transitions to step 740, which is described in greater detail below, when the correlation score is not greater than the score value at position X in the output list.

On the other hand, when the correlation score is determined to be greater than the score value at position X in the output list, the correlation detection, assessment, and scoring process 700 sets (at 725) the score value at position X in the output list to the correlation score (computed at step 715). Then the correlation detection, assessment, and scoring process 700 sets (at 730) an optimal shift value at position X in the output list to Y−X. In other words, the amount of shifting to the right or left that is required for the different segments of the different time data series to visually illustrate the computed correlation is determined by the difference between Y and X Next, the correlation detection, assessment, and scoring process 700 sets (at 735) the optimal segment length at position X in the output list to the present segment length. After setting the values in the output list for position X, the correlation detection, assessment, and scoring process 700 returns to continue walking the time data series for correlation detection and assessment.

In some embodiments, the correlation detection, assessment, and scoring process 700 increases (at 740) the segment length by two (+2). For instance, if the present value of the segment length is set to seven (7), then the updated segment length will be set to nine (9). As noted above, the values of the segment lengths that the a correlation detection, assessment, and scoring process will use depends largely on the type of data for the time data series being assessed. Thus, a person skilled in the relevant art would appreciate that the increase of two (2) for the segment length is intended to be an example, and not intended as limiting embodiments of the correlation detection, assessment, and scoring process.

After the segment length is increased, the correlation detection, assessment, and scoring process 700 of some embodiments determines (at 745) whether the segment length is greater than eleven (11). Again, the value of eleven (11) in this example is intended as merely illustrative, rather than limiting. When the segment length is not greater than eleven (11), the correlation detection, assessment, and scoring process 700 of some embodiments transitions back to step 715 to compute the correlation score (with the same segment starting points, TDS₁(X), TDS₂(Y), but an increased segment length). However, when the segment length is determined to be greater than eleven (11), the correlation detection, assessment, and scoring process 700 of some embodiments determines (at 750) whether the value of variable counter Y is less than the length of time data series TDS₂. When Y is less than the length of time data series TDS₂, then the correlation detection, assessment, and scoring process 700 increments (at 755) the value of Y (e.g., Y=Y+1) and transitions back to step 710 to set the segment length back to seven (7).

On the other hand, when the value of Y is not less than the length of time data series TDS₂, the correlation detection, assessment, and scoring process 700 sets (at 760) the value of Y to one (1). In other words, when Y is equal to or greater than the length of the time data series TDS₂, then walking over time data series TDS₂ will start over (Y=1) with a new (incremented) value of X

Next, the correlation detection, assessment, and scoring process 700 determines (at 765) whether the value of variable counter X is less than the length of time data series TDS₁. When X is less than the length of time data series TDS₁, then the correlation detection, assessment, and scoring process 700 increments (at 770) the value of X (e.g., X=X+1) and transitions back to step 710 to set the segment length back to seven (7). However, when the value of X is not less than the length of time data series TDS₁ (e.g., X is greater than or equal to the length of time data series TDS₁) the correlation detection, assessment, and scoring process 700 returns (at 775) the output list. The output list is returned because the correlation detection, assessment, and scoring process 700 has completely walked over the time data series TDS₁, leaving no more segments or data points to consider. Then the correlation detection, assessment, and scoring process 700 ends.

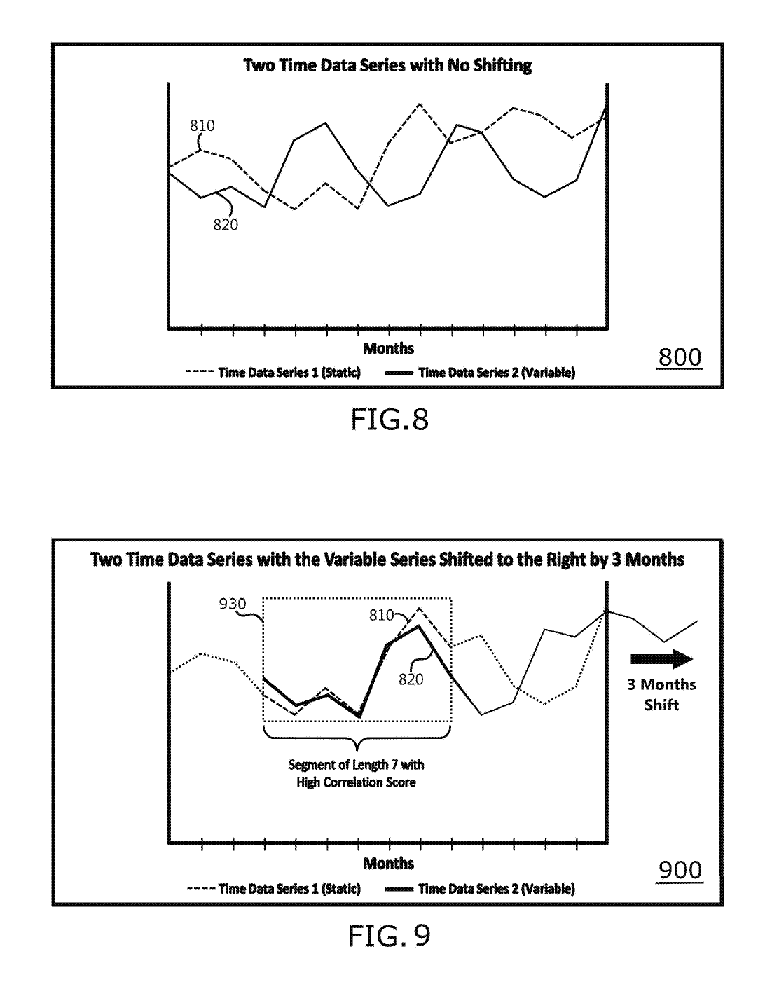

By way of example, FIG. 8 conceptually illustrates a graph 800 that includes two time data series before correlation detection, assessment, and scoring. In particular, the two time data series plotted as curves in graph 800 include a static time data series 810 and a variable time data series 820. In this graph 800, no shifting of time data series 810 or time data series 820 is shown. Notably, the two time data series 810 and 820 do not appear to have segments within them which correlate in their current positions.

By comparison, FIG. 9 conceptually illustrates a graph 900 that includes the variable time data series 820 curve shifted due to a range of data points in the variable time data series 820 that is highly correlated to another range of data points in the static time data series 810 curve. Specifically, the variable time data series 820 curve has been shifted to the right by three months. As shown in dashed box 930, the shift has resulted in a long segment of the variable time data series 820 that has a high correlation score in relation to the static time data series 810. Also, this segment has a length of seven (i.e., the segment spans approximately seven months, staring at the fourth month).

### V. Conflict Resolution Method

When the correlation detection and assessment method above analyzes two time data series it may identify multiple shift values that result in multiple segments with high correlation scores. Furthermore, two or more of any resulting segments may overlap—indicating that there are elements in Time Data Series #2 that represent ‘effects’ that have multiple ‘causes’ in Time Data Series #1.

In some embodiments, a conflict resolution method is employed to sort this out, being based on a premise that each effect should only have one cause. Specifically, the conflict resolution method of some embodiments consumes output from the correlation detection and assessment method and resolves conflicts where overlapping ranges within two time data series comprise multiple correlated periods, each with a different lag factor and correlation quality score.

The method is implemented in such a way that segments representing effects should be associated only with a single cause segment, and where there are multiple causes identified, the method should ‘pick’ the segment that has a higher correlation score. Then, if there are more than 2 sections remaining from the segment with the lower correlation score, they should be represented as a second and difference cause segment. Segments with only one or two sections remaining are judged to be too short to retain and are discarded.

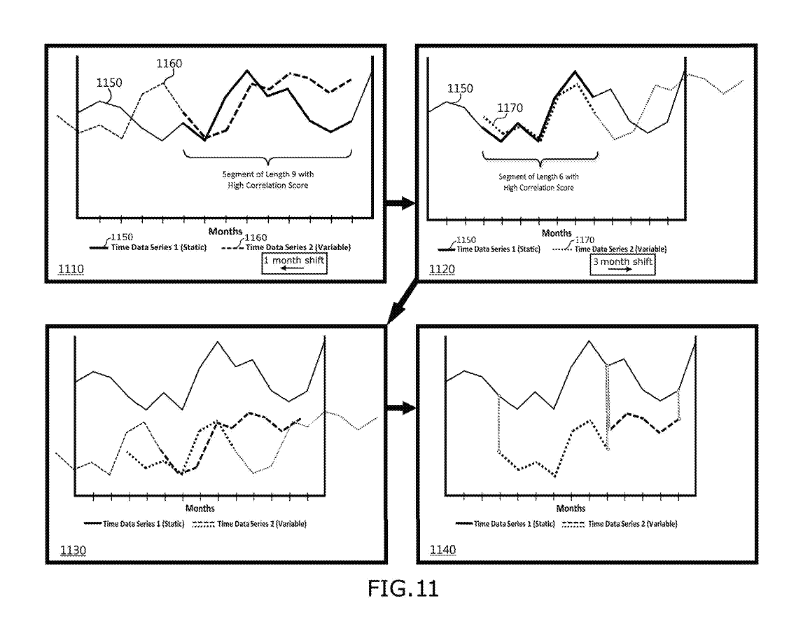

By way of example, FIG. 10 conceptually illustrates a conflict resolution process 1000 for identifying overlapping ranges of data points within two time data series and resolving conflicts of the overlapping ranges. In another example, FIG. 11 conceptually illustrates a series of conflict resolution stages 1110-1140 during which overlapping ranges of data points within two time data series 1160 and 1170 are identified and resolved. Some of the steps of the conflict resolution process 1000 of FIG. 10 are described below by reference to the series of conflict resolution stages 1110-1140 of FIG. 11.

Turning to FIG. 10, the conflict resolution process 1000 starts by retrieving (at 1005) an output list. For example, the conflict resolution process 1000 may retrieve the output list returned by the correlation detection, assessment, and scoring process 700 described above by reference to FIG. 7. The conflict resolution process 1000 of some embodiments then retrieves (at 1010) list entry data from the output list for all segment entries in the output list (e.g., entry number, correlation score, shift value, length, etc.).

With the relevant output list information, the conflict resolution process 1000 of some embodiments positions (at 1015) the head of each segment at a graph position corresponding to the entry number plus the shift value. Next, the conflict resolution process 1000 of some embodiments plots (at 1020) each segment from the position of the segment head to the end of the segment based on the length specified in the output list.

Turning to FIG. 11, a static time data series 1150 is shown at stage 1110 with a variable time data series 1160 having been shifted left by one month to align a nine-month long segment of variable time data series 1160 having a high correlation score with a nine-month long segment of static time data series 1150.

At stage 1120, the static time data series 1150 is shown along with a variable time data series 1170 (different from variable time data series 1160) having been shifted right by three months to align a six-month long segment of variable time data series 1170 having a high correlation score with a six-month long segment of static time data series 1150.

Turning back to FIG. 10, the conflict resolution process 1000 identifies (at 1025) conflicting segments in which data points are plotted for multiple segments.

As shown at stage 1230 of FIG. 11, both of the variable time data series 1160 and 1170 are plotted under the static time data series 1150 with their respective shifted placements. As can be seen at stage 1230, the variable time data series 1160 and 1170 overlap and conflict over their respective spans.

The conflict shown between variable time data series 1160 and 1170 (both having high correlation scores with respect to static time data series 1150) is resolved by the conflict resolution process 1000 of FIG. 10. First, the conflict resolution process 1000 determines (at 1030) the span of each segment in each pair of conflicting segments (i.e., shifted variable time data series 1160 and 1170). Next, the conflict resolution process 1000 identifies (at 1035) a primary segment with a higher correlation value than a secondary segment with a lower correlation value in the pair of conflicting segments. Then the conflict resolution process 1000 plots (at 1040) the primary segment in the graph.

In some embodiments, there are additional overlapping data points of one or the other conflicting segment which may be plotted due to the high correlation value. However, trivial overlapping data points (e.g., an overlap of a single month may be trivial in relation to a long segment of nine months or eleven months). Thus, the conflict resolution process 1000 of some embodiments determines (at 1045) a number of data points of the secondary segment that are outside the span of the primary segment. In some embodiments, the conflict resolution process 1000 determines (at 1050) whether the number of data points outside the span is greater than two (2) data points. Again, the value of two (2) in this example is intended as merely illustrative, rather than limiting.

When the number of data points outside the span is not greater than two, then the conflict resolution process 1000 removes (at 1055) the secondary segment. Then the conflict resolution process 1000 transitions to step 1065, which is described below.

On the other hand, when the number of data points outside the span is greater than two, then the conflict resolution process 1000 plots (at 1060) data points of the secondary segment that are outside the span of the primary segment. Next, the conflict resolution process 1000 determines (at 1065) whether are more pairs to consider. When there are more pairs of conflicting segments, the conflict resolution process 1000 transitions back to step 1035 to identify the primary and secondary segments of the pair. However, when there are no more pairs of conflicting segments, then the conflict resolution process 1000 ends.

Note that the conflict resolution method is premised on the unlikelihood of having a single cause and effect shift across the entire length. Thus, multiple shifts of potentially different magnitudes are acceptable. Also note that the method does not generate shifted views of any range of data across static Time Data Series #1 where no significant correlation is identified.

### VI. Correlation Detection, Assessment, and Scoring System

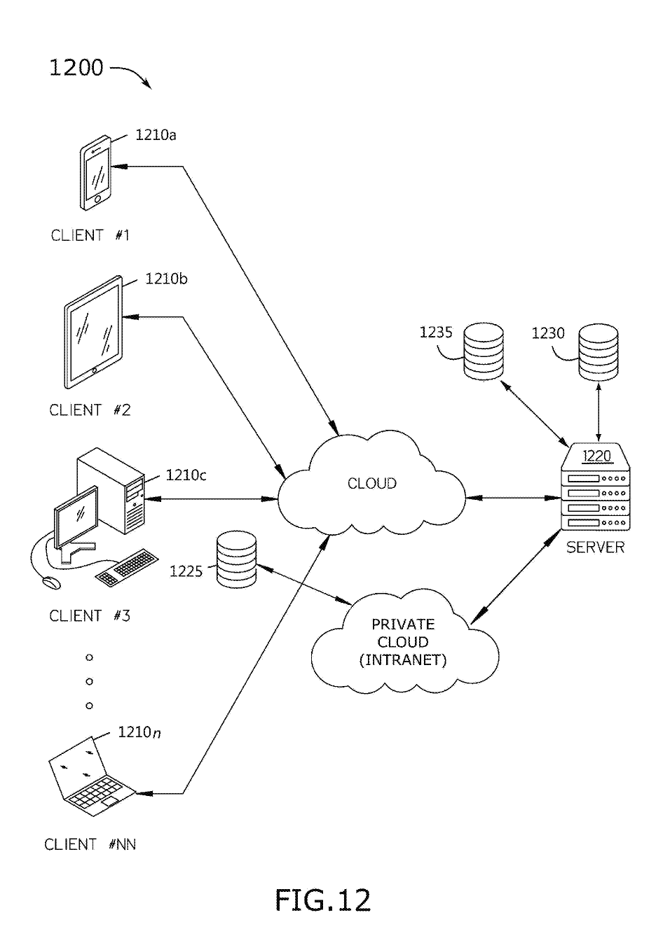

By way of example, FIG. 12 conceptually illustrates a network architecture of a cloud-network correlation detection, assessment, and scoring system 1200 that identifies and understands cause and effect relationships between spending and business metrics, while accounting for differences in data, time, and perception. As shown in this figure, the correlation detection, assessment, and scoring system 1200 includes a plurality of client computing devices 1210a-1210n, a correlation detection, assessment, and scoring server 1220, a private time series data aggregation database 1225, a time series data correlation database 1230, and a cloud-based time series data aggregation database 1235.

The correlation detection, assessment, and scoring server 1220 of some embodiments is a cloud-based server accessible over the Internet. In some embodiments, the correlation detection, assessment, and scoring server 1220 provides an application service for businesses, organizations, or other entities to aggregate, track, and correlate marketing investment expense over time. In some embodiments, the correlation detection, assessment, and scoring server 1220 is indirectly connected to the private time series data aggregation database 1225. For example, the private time series data aggregation database 1225 may be a data source of a business associated with at least one of the client computing devices 1210a-1210n which is accessing or has accessed the correlation detection, assessment, and scoring server 1220. In some such cases, the correlation detection, assessment, and scoring server 1220 may access the private time series data aggregation database 1225 over a secure and private network connection (e.g., private cloud).

In some embodiments, the correlation detection, assessment, and scoring server 1220 is directly connected to the cloud-based time series data aggregation database 1235. For example, a business or entity that uses the cloud-network correlation detection, assessment, and scoring system 1200 may store all-time series data related to one or more of its marketing campaigns in the cloud-based time series data aggregation database 1235, instead of storing the data in some local storage repository. In some embodiments, the correlation detection, assessment, and scoring server 1220 stores individual sets of time series data in the cloud-based time series data aggregation database 1235 in an original (or raw data) format without connection or correlation to other sets of time series data.

In some cases, a business or entity that uses the cloud-network correlation detection, assessment, and scoring system 1200 may store the time series data related to some of its marketing campaigns in the cloud-based time series data aggregation database 1235 while storing time series data related to other marketing campaigns in the private time series data aggregation database 1225.

In some embodiments, the correlation detection, assessment, and scoring server 1220 is connected to the time series data correlation database 1230. In some embodiments, the correlation detection, assessment, and scoring server 1220 retrieves multiple time series data sets from one or both of the private time series data aggregation database 1225 and the cloud-based time series data aggregation database 1235 and then compares the multiple time series data sets to identify any time series data segments that are highly correlated and which may therefore be associated by a cause and effect relationship. In some embodiments, the correlation detection, assessment, and scoring server 1220 correlates any identified pairs of segments from different time series data sets which have a high correlation score and are recognized as being associated through a causal relationship (or rather, a cause and effect relationship).

In some embodiments, the correlation detection, assessment, and scoring server 1220 stores correlated pairs of time series data in the time series data correlation database 1230. The correlated pairs of time series data can then be visually output in a graphical user interface (GUI) of a computer screen or another output display (e.g., a projector) connected to a client computing device 1210a-1210n of a user.

In some embodiments, the correlation detection, assessment, and scoring server 1220 may retrieve strength of correlation parameters that allow the correlation detection, assessment, and scoring server 1220 to incorporate visual indicators in the graphical display of the correlated pairs of time series data and/or the value chain.

Each of the client computing devices 1210a, 1210b, 1210c, and 1210n connects to the correlation detection, assessment, and scoring server 1220 over a network (labeled “cloud” in this figure), such as the Internet (public), or a private network (or labeled “private cloud” in this figure), to identify different time data series that include segments that are highly correlated, and thereby enable one to connect marketing investment to financial impact on revenue, margin, and/or cash flow over time (time-shifting of the segments with high correlation).

To make the correlation detection, assessment, and scoring system 1200, a software developer may create software that implements the methods described above. The software may be installed and run on any one of the client computing devices 1210a-1210n and/or the correlation detection, assessment, and scoring server 1220. The cloud-network correlation detection, assessment, and scoring system 1200 may be deployed over a commercial cloud-computing provider. As such, the cloud-network correlation detection, assessment, and scoring system 1200 may be built on a software as a service (SaaS) architecture, a platform as a service (PaaS) architecture, an infrastructure as a service (IaaS) architecture, or another cloud-computing architecture that includes one or more features of one or more of these types of cloud-computing architectures and/or customized features of other systems.

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention. For instance, the system and methods of the present disclosure are adaptable for use in other areas of business because the logic sequences in the steps of the methods are agnostic. Therefore, an individual could apply the same approaches to other data sets in other areas of the business with similar cause-and-effect questions. Thus, one of ordinary skill in the art would understand that the invention is not to be limited by the foregoing illustrative details, but rather is to be defined by the appended claims.

### VII. Electronic System

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

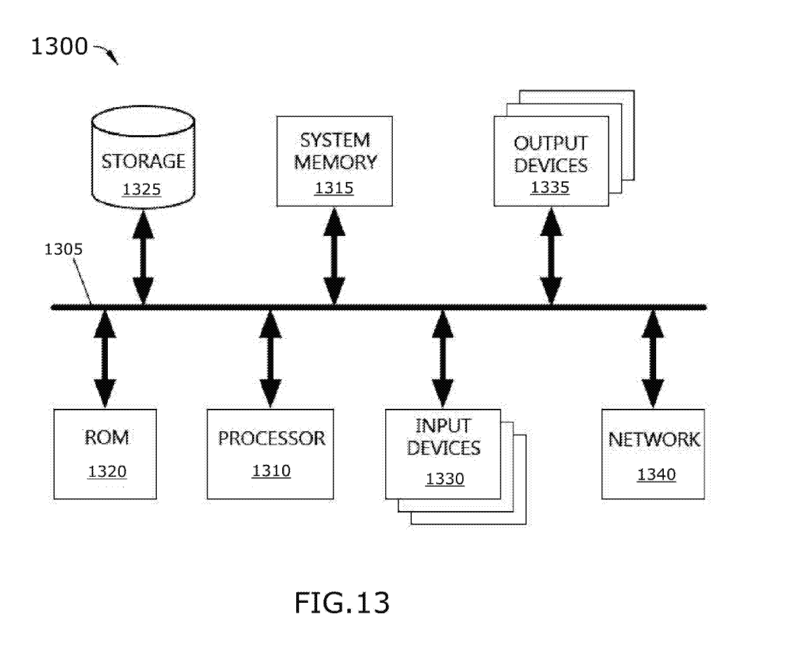

FIG. 13 conceptually illustrates an electronic system 1300 with which some embodiments of the invention are implemented. The electronic system 1300 may be a computer, phone, PDA, tablet, or any other sort of electronic device. Such an electronic system includes various types of computer readable media and interfaces for various other types of computer readable media. Electronic system 1300 includes a bus 1305, processing unit(s) 1310, a system memory 1315, a read-only 1320, a permanent storage device 1325, input devices 1330, output devices 1335, and a network 1340.

The bus 1305 collectively represents all system, peripheral, and chipset buses that communicatively connect the numerous internal devices of the electronic system 1300. For instance, the bus 1305 communicatively connects the processing unit(s) 1310 with the read-only 1320, the system memory 1315, and the permanent storage device 1325.

From these various memory units, the processing unit(s) 1310 retrieves instructions to execute and data to process in order to execute the processes of the invention. The processing unit(s) may be a single processor or a multi-core processor in different embodiments.

The read-only-memory (ROM) 1320 stores static data and instructions that are needed by the processing unit(s) 1310 and other modules of the electronic system. The permanent storage device 1325, on the other hand, is a read-and-write memory device. This device is a non-volatile memory unit that stores instructions and data even when the electronic system 1300 is off. Some embodiments of the invention use a mass-storage device (such as a magnetic or optical disk and its corresponding disk drive) as the permanent storage device 1325.

Other embodiments use a removable storage device (such as a floppy disk or a flash drive) as the permanent storage device 1325. Like the permanent storage device 1325, the system memory 1315 is a read-and-write memory device. However, unlike storage device 1325, the system memory 1315 is a volatile read-and-write memory, such as a random access memory. The system memory 1315 stores some of the instructions and data that the processor needs at runtime. In some embodiments, the invention's processes are stored in the system memory 1315, the permanent storage device 1325, and/or the read-only 1320. For example, the various memory units include instructions for processing appearance alterations of displayable characters in accordance with some embodiments. From these various memory units, the processing unit(s) 1310 retrieves instructions to execute and data to process in order to execute the processes of some embodiments.

The bus 1305 also connects to the input and output devices 1330 and 1335. The input devices enable the user to communicate information and select commands to the electronic system. The input devices 1330 include alphanumeric keyboards and pointing devices (also called “cursor control devices”). The output devices 1335 display images generated by the electronic system 1300. The output devices 1335 include printers and display devices, such as cathode ray tubes (CRT) or liquid crystal displays (LCD). Some embodiments include devices such as a touchscreen that functions as both input and output devices.

Finally, as shown in FIG. 13, bus 1305 also couples electronic system 1300 to a network 1340 through a network adapter (not shown). In this manner, the computer can be a part of a network of computers (such as a local area network (“LAN”), a wide area network (“WAN”), or an intranet), or a network of networks (such as the Internet). Any or all components of electronic system 1300 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIGS. 1, 2, 4, 6, 7, and 10 conceptually illustrate methods in which the specific operations of each method may not be performed in the exact order shown and described. Specific operations may not be performed in one continuous series of operations, and different specific operations may be performed in different embodiments. Furthermore, each method could be implemented using several sub-methods, or as part of a larger macro method. Thus, one of ordinary skill in the art would understand that the invention is not to be limited by the foregoing illustrative details, but rather is to be defined by the appended claims.

I claim:

1. A proof correlation process for identifying and understanding cause and effect relationships between spending and business metrics, while accounting for differences in data, time, and perception, said process comprising:
a set of data smoothing operations for smoothing one or more time data series;
a set of time data series scaling operations;
a set of correlation detection and assessment operations; and
a set of conflict resolution operations which consumes output from the correlation detection and assessment operations and resolve conflicts where overlapping ranges within two time data series include multiple correlated periods, each with a different lag factor and correlation quality score.
